(19) United States
(12) Patent Application Publication
(10) Pub. No.: US 2021/0088652 A1
(43) Pub. Date: Mar. 25, 2021

(54) VEHICULAR MONITORING SYSTEMS AND METHODS FOR SENSING EXTERNAL OBJECTS

(71) Applicant: A^3 by Airbus LLC, Sunnyvale, CA (US)

(72) Inventor: Arne Stoschek, Palo Alto, CA (US)

(73) Assignee: A^3 by Airbus LLC, Sunnyvale, CA (US)

(21) Appl. No.: 16/498,982

(22) PCT Filed: Mar. 31, 2017
(86) PCT No.: PCT/US17/25520

§ 371 Date: Sep. 27, 2019

(51) Int. Cl. G01S 13/933; G01S 13/931; G01S 13/86; B64D 45/00; B64D 47/08

(52) U.S. Cl. CPC G01S 13/933; G01S 13/931; B64D 47/08; G01S 13/867; B64D 45/00; G01S 13/865

(57) ABSTRACT

A monitoring system (5) for a vehicle (10) has sensors (20, 30) that are used to sense the presence of objects (15) around the vehicle for collision avoidance, navigation, or other purposes. At least one of the sensors (20), referred to as a “primary sensor,” may be configured to sense objects within its field of view (25) and provide data indicative of the sensed objects. The monitoring system may use such data to track the sensed objects. A verification sensor (30), such as a radar sensor, may be used to verify the data from the primary sensor from time-to-time without tracking the objects around the vehicle with data from the verification sensor.

### BACKGROUND

Many vehicles have sensors for sensing external objects for various purposes. For example, drivers or pilots of vehicles, such as automobiles, boats, or aircraft, may encounter a wide variety of collision risks, such as debris, other vehicles, equipment, buildings, birds, terrain, and other objects. Collision with any such object may cause significant damage to a vehicle and, in some cases, injure its occupants. Sensors can be used to detect objects that pose a collision risk and warn a driver or pilot of the detected collision risks. If a vehicle is self-driven or self-piloted, sensor data indicative of objects around the vehicle may be used by a controller to avoid collision with the detected objects. In other examples, objects may be sensed and identified for assisting with navigation or control of the vehicle in other ways.

To ensure safe and efficient operation of a vehicle, it is desirable for the sensors used to detect external objects to be accurate and reliable. However, ensuring reliable operation of such sensors in all situations can be difficult. As an example, for an aircraft, it is possible for there to be a large number of objects within its vicinity, and such objects may be located in any direction from the aircraft. Further, such objects may be moving rapidly relative to the aircraft, and any failure to accurately detect an object or its location can be catastrophic. Sensors capable of reliably detecting objects under such conditions may be expensive or subject to burdensome regulatory restrictions.

Improved techniques for reliably detecting objects within a vicinity of a vehicle are generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 depicts a top perspective view of a vehicle having a vehicular monitoring system in accordance with some embodiments of the present disclosure.

FIG. 2 depicts a three-dimensional perspective view of the vehicle depicted by FIG. 1.

FIG. 3 depicts a top perspective view of the vehicle depicted by FIG. 1.

FIG. 4 is a block diagram illustrating various components of a vehicular monitoring system in accordance with some embodiments of the present disclosure;

FIG. 5 is a block diagram illustrating a data processing element for processing sensor data in accordance with some embodiments of the present disclosure; and

FIG. 6 is a flow chart illustrating a method for verifying sensor data in accordance with some embodiments of the present disclosure.

### DETAILED DESCRIPTION

The present disclosure generally pertains to vehicular monitoring systems and methods for sensing external objects. In some embodiments, a vehicle includes a vehicular monitoring system having sensors that are used to sense the presence of objects around the vehicle for collision avoidance, navigation, or other purposes. At least one of the sensors may be configured to sense objects within the sensor's field of view and provide sensor data indicative of the sensed objects. The vehicle may then be controlled based on the sensor data. As an example, the speed or direction of the vehicle may be controlled in order to avoid collision with a sensed object, to navigate the vehicle to a desired location relative to a sensed object, or to control the vehicle for other purposes.

To help ensure safe and efficient operation of the vehicle, it is generally desirable for the vehicular monitoring system to reliably and accurately detect and track objects around the vehicle, particularly objects that may be sufficiently close to the vehicle to pose a significant collision threat. In some embodiments, the space around a vehicle is monitored by sensors of different types in order to provide sensor redundancy, thereby reducing the likelihood that an object within the monitored space is missed. As an example, objects around the vehicle may be detected and tracked with a sensor of a first type (referred to hereafter as a “primary sensor”), such as a LIDAR sensor or an optical camera, and a sensor of a second type (referred to hereafter as a “verification sensor”), such as a radar sensor, may be used to verify the accuracy of the sensor data from the primary sensor. That is, data from the verification sensor may be compared with the data from the primary sensor to confirm that the primary sensor has accurately detected all objects within a given field of view. If a discrepancy exists between the sensor data of the primary sensor and the data of the verification sensor (e.g., if the primary sensor fails to detect an object detected by the verification sensor or if the location of an object detected by the primary sensor does not match the location of the same object detected by the verification sensor), then at least one action can be taken in response to the discrepancy. As an example, the vehicle can be controlled to steer it clear of the region corresponding to the discrepancy or the confidence of the sensor data from the primary sensor can be changed (e.g., lowered) in a control algorithm for controlling the vehicle.

In some embodiments, a radar sensor is used to implement a verification sensor for verifying the data of a primary sensor. If desired, such a radar sensor can be used to detect and track objects similar to the primary sensor. However, the use of a radar sensor in an aircraft to track objects may be regulated, thereby increasing the costs or burdens associated with using a radar sensor in such an application. In some embodiments, a radar sensor is used to verify the sensor data from a primary sensor from time-to-time without actually tracking the detected objects with the radar sensor over time. That is, the primary sensor is used to track objects around the vehicle, and the radar sensor from time-to-time is used to provide a sample of data indicative of the objects currently around the aircraft. This sample may then be compared to the data from the primary sensor to confirm that the primary sensor has accurately sensed the presence and location of each object within the primary sensor's field of view. Thus, the radar sensor may be used to verify the sensor data from the primary sensor from time-to-time without tracking the objects around the vehicle with the radar sensor, thereby possibly avoiding at least some regulatory restrictions associated with the use of the radar sensor. In addition, using the radar sensor in such manner to verify the sensor data from the primary sensor from time-to-time without using the data from the radar sensor for tracking helps to reduce the amount of data that needs to be processed or stored by the vehicular monitoring system.

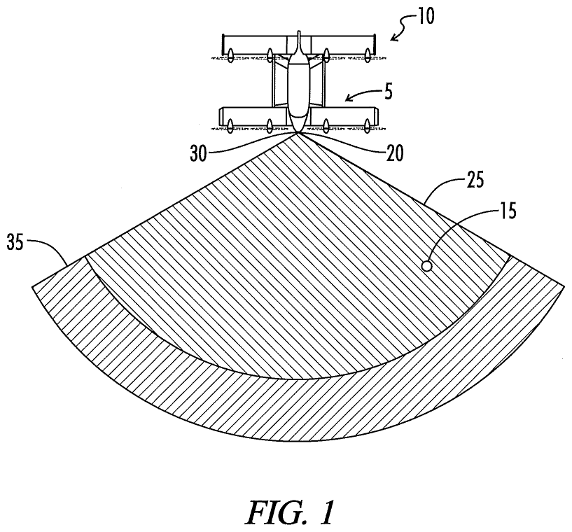

FIG. 1 depicts a top perspective view of a vehicle 10 having a vehicular monitoring system 5 that is used to sense objects around the vehicle 10 in accordance with some embodiments of the present disclosure. The system 5 has a plurality of sensors 20, 30 to detect objects 15 that are within a certain vicinity of the vehicle 10, such as near a path of the vehicle 10. The system 5 may determine that an object 15 poses a threat to the vehicle 10, such as when the object 15 has a position or velocity that will place it near or within a path of the vehicle 10 as it travels. In such cases, the vehicle 10 may provide a warning to a pilot or driver or autonomously take evasive action in an attempt to avoid the object 15. In other examples, the system 5 may use the detection of the object 15 for other purposes. As an example, the system 5 may use a detected object 15 as a point of reference for navigating the vehicle 10 or, when the vehicle 10 is an aircraft, controlling the aircraft during a takeoff or landing.

In some embodiments, the vehicle 10 may be an aircraft as is depicted in FIG. 1, but other types of vehicles 10 are possible in other embodiments. The vehicle 10 may be manned or unmanned, and may be configured to operate under control from various sources. For example, the vehicle 10 may be an aircraft (e.g., an airplane or helicopter) controlled by a human pilot, who may be positioned onboard the vehicle 10. In other embodiments, the vehicle 10 may be configured to operate under remote control, such by wireless (e.g., radio) communication with a remote pilot or driver. In some embodiments, the vehicle 10 may be self-piloted or self-driven (e.g., a drone). In the embodiment shown by FIG. 1, the vehicle 10 is a self-piloted vertical takeoff and landing (VTOL) aircraft, such as is described by PCT Application No. PCT/US17/18182, entitled “Self-Piloted Aircraft for Passenger or Cargo Transportation” and filed on Feb. 16, 2017, which is incorporated herein by reference. Various other types of vehicles may be used in other embodiments, such as automobiles or boats.

The object 15 of FIG. 1 is depicted as a single object that has a specific size and shape, but it will be understood that object 15 may have various characteristics. In addition, although a single object 15 is depicted by FIG. 1, the airspace around the vehicle 10 may include any number of objects 15. An object 15 may be stationary, as when the object 15 is a building, but in some embodiments, the object 15 is capable of motion. For example, the object 15 may be another vehicle in motion along a path that may pose a risk of collision with the vehicle 10. The object 15 may be other obstacles posing a risk to safe operation of vehicle 10 in other embodiments, or the object 15 may be used for navigation or other purposes during operation of the vehicle 10.

In some embodiments, an object 15 may be one of tens, hundreds or even thousands of other aircraft that vehicle 10 may encounter at various times as it travels. For example, when vehicle 10 is a self-piloted VTOL aircraft, it may be common for other similar self-piloted VTOL aircraft to be operating close by. In some areas, such as urban or industrial sites, use of smaller unmanned aircraft may be pervasive. In this regard, vehicular monitoring system 5 may need to monitor locations and velocities of each of a host of objects 15 that may be within a certain vicinity around the aircraft, determine whether any object presents a collision threat and take action if so.

FIG. 1 also depicts a sensor 20, referred to hereafter as “primary sensor,” having a field of view 25 in which the sensor 20 may detect the presence of objects 15, and the system 5 may use the data from the sensor 20 to track the objects 15 for various purposes, such as collision avoidance, navigation, or other purposes. FIG. 1 also depicts a sensor 30, referred to hereafter as “verification sensor,” that has a field of view 35 in which it may sense objects 15. Field of view 25 and field of view 35 are depicted by FIG. 1 as substantially overlapping, though the field of view 35 extends a greater range from the vehicle 10. In some embodiments, the field of view 35 of the verification sensor 30 may be greater than the field of view 25 of the primary sensor 20 (e.g., extend completely around the vehicle 10 as will be described in more detail below). In this regard, data sensed by the verification sensor 30 may be used by the vehicular monitoring system 5 to verify data sensed by sensor 20, (e.g., confirm detection of one or more objects 15). Note that, unless stated explicitly otherwise herein, the term “field of view,” as used herein, does not imply that a sensor is optical, but rather generally refers to the region over which a sensor is capable of sensing objects regardless of the type of sensor that is employed.

The sensor 20 may be of various types or combinations of types of sensors for monitoring space around vehicle 10. In some embodiments, the sensor 20 may sense the presence of an object 15 within the field of view 25 and provide sensor data indicative of a location of the object 15. Such sensor data may then be processed for various purposes, such as navigating the vehicle 10 or determining whether the object 15 presents a collision threat to the vehicle 10, as will be described in more detail below.

In some embodiments, the sensor 20 may include at least one camera for capturing images of a scene and providing data defining the captured scene. Such data may define a plurality of pixels where each pixel represents a portion of the captured scene and includes a color value and a set of coordinates indicative of the pixel's location within the image. The data may be analyzed by the system 5 to identify objects 15. In some embodiments, the system 5 has a plurality of primary sensors 20 (e.g., cameras), wherein each primary sensor 20 is configured for sensing (e.g., focusing on) objects at different distances (e.g., 200 m, 600 m, 800 m, 1 km, etc.) within the field of view 25 relative to the other sensors 20 (e.g., each camera has a lens with a different focal length). In other embodiments, single sensor 20 may have one or more lenses configured to sense the different distances. In some embodiments, other types of sensors are possible. As an example, the sensor 20 may comprise any optical or non-optical sensor for detecting the presence of objects, such as an electro-optical or infrared (EO/IR) sensor, a light detection and ranging (LIDAR) sensor, or other type of sensor.

As described above, the sensor 20 may have a field of view 25 defining a space in which the sensor 20 may sense objects 15. The field of view 25 may cover various regions, including two-dimensional and three-dimensional spaces, and may have various shapes or profiles. In some embodiments, the field of view 25 may be a three-dimensional space having dimensions that depend on the characteristics of the sensor 20. For example, where sensor 20 comprises one or more optical cameras, field of view 25 may be related to properties of the camera (e.g., lens focal length, etc.). Note, however, that in the embodiment of FIG. 1, it is possible that the field of view 25 may not have a shape or profile allowing the sensor 20 to monitor all space surrounding vehicle 10. In this regard, additional sensors may be used to expand the area in which the system 5 can detect objects so that a scope of sensing that will enable safe, self-piloted operation of the vehicle 10 may be achieved.

Note that the data from the sensor 20 may be used to perform primary tracking operations of objects within the field of view 25 independently of whether any additional sensor (e.g., verification sensor 30) may sense all or a portion of field of view 25. In this regard, vehicular monitoring system 5 may rely primarily upon sensor data from sensor 20 to identify and track an object 15. The system 5 may use data from other sensors in various ways, such as verification, redundancy, or sensory augmentation purposes, as described herein.

FIG. 1 shows a verification sensor 30 having a field of view 35 that is generally co-extensive with the field of view 25 of sensor 20. In some embodiments, the verification sensor 30 comprises a radar sensor for providing data that is different from the data provided by sensor 20 but that permits verification of the data provided by sensor 20. In other words, verification sensor 30 may be configured so that its field of view 35 permits vehicular monitoring system 5 to perform verification (e.g., redundant sensing) of objects 15 within the field of view 25 of sensor 20. For illustrative purposes, unless otherwise indicated, it will be assumed hereafter that each primary sensor 20 is implemented as a camera that captures images of scenes within its respective field of view, while verification sensor 30 is implemented as a radar sensor with a field of view 35 that covers locations in the field of view 25 of the primary sensor 20, but it should be emphasized that other types of sensors 20, 30 may be used as may be desired to achieve the functionality described herein.

When the verification sensor 30 is implemented as a radar sensor, the sensor 30 may have a transmitter for emitting pulses into the space being monitored by the sensor 30 and a receiver for receiving returns reflected from objects 15 within the monitored space. Based on the return from an object, the verification sensor 30 can estimate the object's size, shape, and location. In some embodiments, the verification sensor may be mounted at a fixed position on the vehicle 10, and if desired, multiple verification sensors 30 can be used to monitor different fields of view around the vehicle 10. When the vehicle 10 is an aircraft, the sensors 20, 30 may be configured to monitor in all directions around the aircraft, including above and below the aircraft and around all sides of the aircraft. Thus, an object approaching from any angle can be detected by both the primary sensor(s) 20 and the verification sensor(s) 30. As an example, there may be multiple sensors 20, 30 oriented in various directions so that the composite field of view of all of the primary sensors 20 and the composite field of view of all of the verification sensors 30 completely surround the vehicle 10.

In some embodiments, a primary sensor 20 or a verification sensor 30 may be movable so that the sensor 20, 30 can monitor different fields of views at different times as the sensor 20, 30 moves. As an example, the verification sensor 30 may be configured to rotate so that a 360 degree field of view is obtainable. As the sensor 30 rotates, it takes measurements from different sectors. Further, after performing a 360 degree scan (or other angle of scan) of the space around the vehicle 10, the verification sensor 30 may change its elevation and perform another scan. By repeating this process, the verification sensor 30 may perform multiple scans at different elevations in order to monitor the space around the vehicle 10 in all directions. In some embodiments, multiple verification sensors 30 may be used to perform scans in different directions. As an example, a verification sensor 30 on a top surface of the vehicle 30 may perform scans of the hemisphere above the vehicle 10, and a verification sensor 30 on a bottom surface of the vehicle 30 may perform scans of the hemisphere below the vehicle 30. In such example, the verification data form both verification sensors 30 may be used monitor the space within a complete sphere around the vehicle 10 so that an object can be sensed regardless of its angle from the vehicle 10.

During operation of the vehicle 10, the sensor data from a primary sensor 20 is analyzed to detect the presence of one or more objects 15 within the sensor's field of view 25. As an example, for each detected object, the sensor data may define a set of coordinates indicative of the object's location relative to the vehicle 10 or some other reference point. The sensor data may also indicate other attributes about the detected object, such as the object's size and/or shape. Over time, the sensor data is used to track the object's position. As an example, for each sample of the sensor data, the object's location and/or other attributes may be stored, and multiple stored samples of this data showing changes to the object's location over time may be used to determine the object's velocity. Based on the object's velocity and location, the vehicle 10 may be controlled according to a desired control algorithm. As an example, the speed or direction of the vehicle 10 may be controlled (either automatically or manually) to avoid a collision with the detected object or to navigate the vehicle 10 to a desired location based on the location of the detected object. For example, the detected object may be used as a point of reference to direct the vehicle 10 to a desired destination or other location.

As described above, the verification data from at least one verification sensor 30 may be used from time-to-time to verify the accuracy of the sensor data from at least one primary sensor 20 by comparing samples captured simultaneously by both sensors 20, 30, as will be described in more detail below. In this regard, when a verification of the sensor data is to occur, the verification sensor 30 may capture a sample of verification data for which at least a portion of the verification data corresponds to the field of view 35 of the primary sensor 20. That is, the field of view 35 of the verification sensor 25 overlaps with the field of view 25 of the primary sensor 20 to provide sensor redundancy such that the sample of verification data indicates whether the verification sensor 30 senses any object 15 that is located within the field of view 25 of the primary sensor 20.

Thus, when an object 15 is within the field of view 25 of the primary sensor 20, it should be sensed by both the primary sensor 20 and the verification sensor 30. The monitoring system 5 is configured to identify the object 15 in both the sample of sensor data from the primary sensor 20 and the sample of verification data from the verification sensor 30 to confirm that both sensors 20, 30 detect the object 15. In addition, the monitoring system 5 also determines whether the location of the object 15 indicated by the sample of sensor data from the primary sensor 20 matches (within a predefined tolerance) the location of the object 15 indicated by the sample of verification data from the verification sensor 30. If each object detected by the verification sensor 30 within the field of view 25 of the primary sensor 20 is also detected by the primary sensor 20 and if the location of each object is the same (within a predefined tolerance) in both samples, then the monitoring system 5 verifies the accuracy of the sensor data from the primary sensor 20 such that it may be relied on for making control decisions as may be desired. However, if an object detected by the verification sensor 30 within the field of view 25 of the primary sensor 20 is not detected by the primary sensor 20 or if the location of a detected object 15 is different in the sample of sensor data from the primary sensor 20 relative to the location of the same object 15 in the sample of verification data from the verification sensor 30, then the monitoring system 5 does not verify the accuracy of the sensor data from the primary sensor 20. In such case, the monitoring system 5 may provide a warning indicating that a discrepancy has been detected between the primary sensor 20 and the verification sensor 30. Various actions may be taken in response to such warning.

As an example, a warning notification (such as a message) may be displayed or otherwise provided to a user, such as a pilot or driver of the vehicle 10. In the case of a self-piloted or self-driven vehicle, the speed or direction of the vehicle 10 may be automatically controlled in response to the warning notification. For example, the vehicle 10 may be steered away from the region corresponding where the discrepancy was sensed so as to avoid collision with the object that the primary sensor 20 failed to accurately detect. In some embodiments, the sensor data from the primary sensor 20 may be associated with a confidence value indicative of the system's confidence in the sensor data. Such confidence value may be lowered or otherwise adjusted to indicate that there is less confidence in the sensor data in response to the detection of a discrepancy between the sensor data from the primary sensor 20 and the verification data from the verification sensor 30. The control algorithm used to control the vehicle 10 may use the confidence value in making control decisions as may be desired. Various other actions may be taken in response to the warning provided when a discrepancy is detected between the sensor data and the verification data.

When comparing samples of the verification data and the sample data, there may be several objects 15 within the field of view 25 of the primary sensor 20, and the monitoring system 5 may be configured to identify the same object in both sets of data so that its location in both sets of data can be compared, as described above. As an example, the monitoring system 5 may be configured to analyze the sample of the sensor data to estimate a size and/or shape of each object sensed by the primary sensor 20, and the monitoring system 5 also may be configured to analyze the sample of the verification data to estimate the size and/or shape of each object sensed by the verification sensor 30. The same object may be identified in both samples when its size and/or shape in the sensor date matches (within a predefined tolerance) its size and/or shape in the verification data. Once the same object has been identified, its location indicated by the sensor data may be compared to its location indicated by the verification data in order to verify the accuracy of the sensor data, as described above.

As briefly discussed above, it should be noted that fields of views of the primary sensors 20 and the verification sensors 30 may be three-dimensional to assist with monitoring three-dimensional airspace around the vehicle 10. Indeed, it is possible for the fields of view to completely surround the vehicle 10 so that an object 15 can be sensed regardless of its direction from the vehicle 10. Such coverage may be particularly beneficial for aircraft for which object may approach the aircraft from any direction.

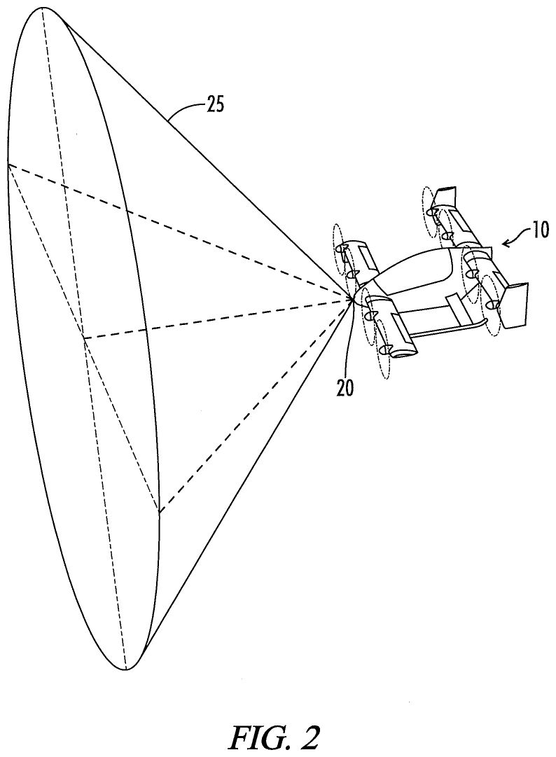

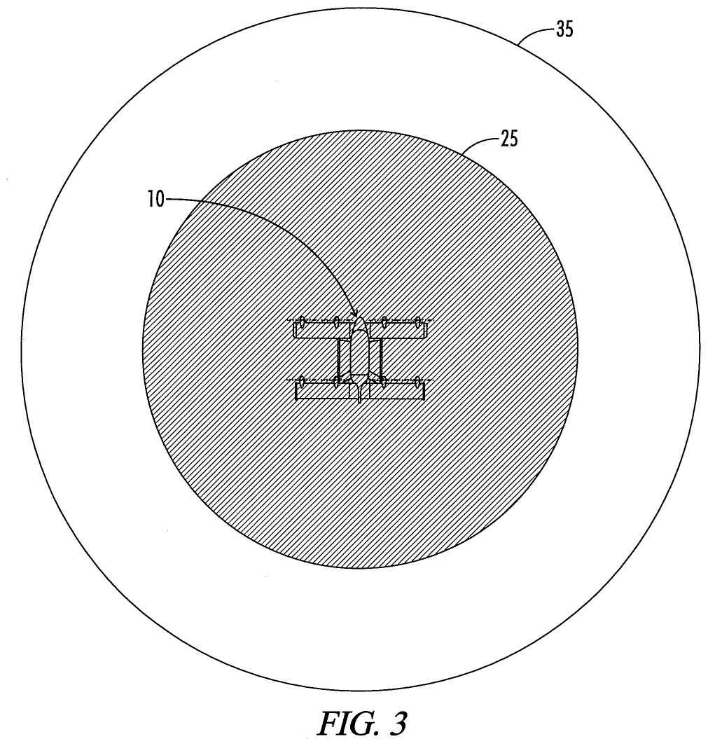

In this regard, the field of view 25 for the sensor 20 shown by FIG. 2 is three-dimensional. Additional sensors (not shown in FIG. 2) may be at other locations on the vehicle 10 such that the fields of view 25 of all of the sensors 20 completely encircle the vehicle 10 in all directions, as shown by FIG. 3. Note that such fields of view, when aggregated together, may form a sphere of airspace completely surrounding the vehicle 10 such that an object 15 approaching the vehicle 10 within a certain range should be within the field of view of at least one primary sensor 20 and, therefore, sensed by at least one primary sensor 20 regardless of its direction from the vehicle 10. In some embodiments, a single primary sensor 20 having a field of view 25 similar to the one shown by FIG. 3 may be used thereby obviating the need to have multiple primary sensors to observe the airspace completely surrounding the vehicle 20.

Similarly, the field of view 35 of the verification sensor 30 may also be three-dimensional. As an example, a radar sensor performing scans at multiple elevations may have a field of view 35 that completely encircles the vehicle 10 in all directions, as shown by FIG. 3. Note that such field of view may form a sphere of airspace completely surrounding the vehicle 10 such that an object 15 approaching the vehicle 10 within a certain range should be sensed by the verification sensor 30 regardless of its direction from the vehicle 10. Notably, in such embodiment, the field of view 35 of the verification sensor 30 may overlap with multiple fields of view 25 of multiple primary sensors 20 such that the same verification sensor 30 may be used to verify sensor data from multiple primary sensors 20. If desired, multiple verification sensors 30 may be used to form an aggregated field of view similar to the one shown by FIG. 3.

It should also be noted that it is unnecessary for the monitoring system 5 to use the verification data from the verification sensor 30 to track the objects 15 sensed by the verification sensor 30. As an example, between verifications of the sensor data, it is unnecessary for the verification sensor 30 to sense objects. If the verification sensor 30 provides any samples between verifications, the monitoring system 5 may discard such samples without analyzing them or using them to track or determine the locations of objects 15. Further, after using a sample of verification data from the verification sensor 30 to verify a sample of the sensor data from the primary sensor 20, the monitoring system 5 may discard the sample of the verification data. Thus, from time-to-time (e.g., periodically), the verification data is used to verify the accuracy of the sensor data from one or more primary sensors 20 without using the verification data to track the objects 15. That is, the monitoring system 5 may use the sensor data from the primary sensor 20 to track objects 15 in the airspace surrounding the vehicle 10 and may use the verification data for the sole purpose of verifying the sensor data without using the verification data to separately track the objects. By not tracking objects with the verification data from the verification sensor 30, it is possible that at least some regulatory restrictions pertaining to the use of the verification sensor 30 would not apply. In addition, the amount of verification data to be processed and stored by the monitoring system 5 may be reduced.

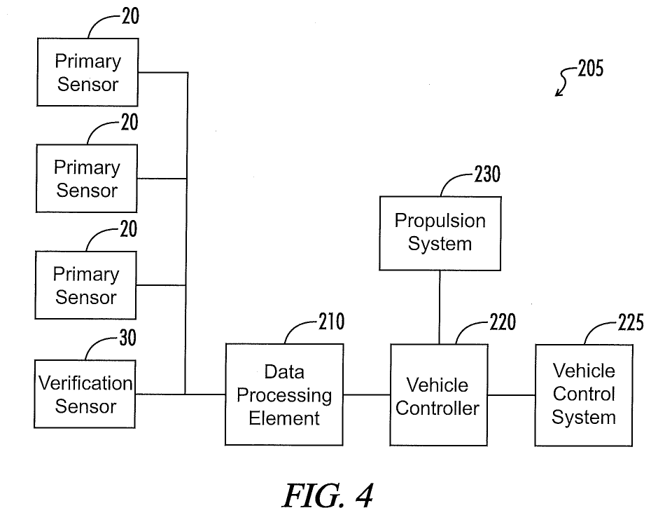

FIG. 4 depicts an exemplary embodiment of a vehicular monitoring system 205 in accordance with some embodiments of the present disclosure. In some embodiments, the vehicular monitoring system 205 is configured for monitoring and controlling operation of a self-piloted VTOL aircraft, but the system 205 may be configured for other types of vehicles in other embodiments. The vehicular monitoring system 205 of FIG. 4 may include a data processing element 210, one or more primary sensors 20, one or more verification sensors 30, a vehicle controller 220, a vehicle control system 225 and a propulsion system 230. Although particular functionality may be ascribed to various components of the vehicular monitoring system 205, it will be understood that such functionality may be performed by one or more components the system 205 in some embodiments. In addition, in some embodiments, components of the system 205 may reside on the vehicle 10 or otherwise, and may communicate with other components of the system 205 via various techniques, including wired (e.g., conductive) or wireless communication (e.g., using a wireless network or short-range wireless protocol, such as Bluetooth). Further, the system 205 may comprise various components not depicted in FIG. 4 for achieving the functionality described herein and generally performing collision threat-sensing operations and vehicle control.

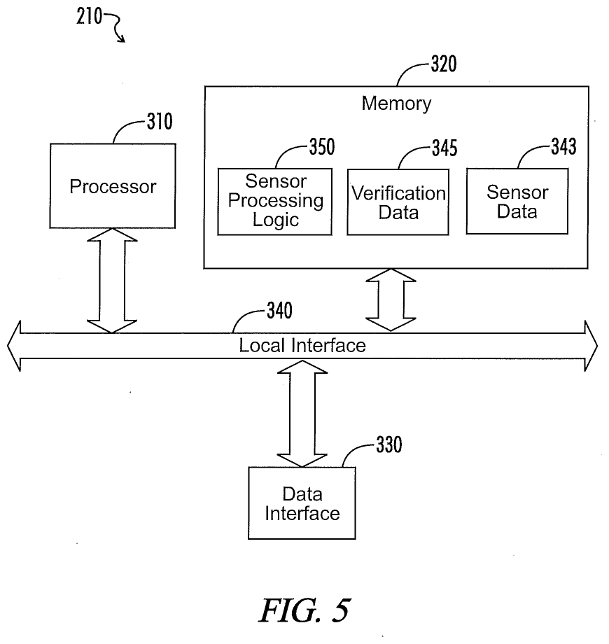

In some embodiments, as shown by FIG. 4, the data processing element 210 may be coupled to each sensor 20, 30, may process sensor data from a primary sensor 20 and a verification sensor 30, and may provide signals to the vehicle controller 220 for controlling the vehicle 10. The data processing element 210 may be various types of devices capable of receiving and processing sensor data from sensor 20 and verification sensor 30, and may be implemented in hardware or a combination of hardware and software. An exemplary configuration of the data processing element 210 will be described in more detail below with reference to FIG. 5.

The vehicle controller 220 may include various components for controlling operation of the vehicle 10, and may be implemented in hardware or a combination of hardware and software. As an example, the vehicle controller 220 may comprise one or more processors (not specifically shown) programmed with instructions for performing the functions described herein for the vehicle controller 220. In some embodiments, the vehicle controller 220 may be communicatively coupled to other components of system 205, including data processing element 210 (as described above, for example), vehicle control system 225, and propulsion system 230.

Vehicle control system 225 may include various components for controlling the vehicle 10 as it travels. As an example, for a self-piloted VTOL aircraft, the vehicle control system 225 may include flight control surfaces, such as one or more rudders, ailerons, elevators, flaps, spoilers, brakes, or other types of aerodynamic devices typically used to control an aircraft. Further, the propulsion system 230 may comprise various components, such as engines and propellers, for providing propulsion or thrust to a vehicle 10. As will be described in more detail hereafter, when the data processing element 210 identifies a collision threat, the vehicle controller 220 may be configured to take an action in response to the threat, such as a provide a warning to a user (e.g., a pilot or driver) or may itself control the vehicle control system 225 and the propulsion system 230 to change the path of the vehicle 10 in an effort to avoid the sensed threat.

FIG. 5 depicts an exemplary data processing element 210 in accordance with some embodiments of the present disclosure. The data processing element 210 may include one or more processors 310, memory 320, a data interface 330 and a local interface 340. The processor 310, e.g., a central processing unit (CPU) or a digital signal processor (DSP), may be configured to execute instructions stored in memory in order to perform various functions, such as processing of sensor data from each of a primary sensor 20 and a verification sensor 30 (FIG. 4). The processor 310 may communicate to and drive the other elements within the data processing element 305 via the local interface 340, which can include at least one bus. Further, the data interface 330 (e.g., ports or pins) may interface components of the data processing element 210 with other components of the system 5, such as the sensor 20 and verification sensor 30 and the vehicle controller 220.

As shown by FIG. 5, the data processing element 210 may comprise sensor processing logic 350, which may be implemented in hardware, software or any combination thereof. In FIG. 5, the sensor processing logic 350 is implemented in software and stored in memory 320. However, other configurations of the sensor processing logic 350 are possible in other embodiments.

Note that the sensor processing logic 350, when implemented in software, can be stored and transported on any computer-readable medium for use by or in connection with an instruction execution apparatus that can fetch and execute instructions. In the context of this document, a “computer-readable medium” can be any means that can contain or store code for use by or in connection with the instruction execution apparatus.

The sensor processing logic 350 is configured to verify the accuracy of the sensor data 343 from a sensor 20 by processing the sensor data 343 and verification data 345 from verification sensor 30 according to the techniques described herein. As an example, the sensor processing logic 350 may be configured to identify objects 15 sensed by the sensors 20, 30 and to assess whether each sensed object 15 poses a collision threat to the vehicle 10 based on the object's location and velocity relative to the vehicle 10 and the vehicle's velocity or expected path of travel. Once the sensor processing logic 350 determines that an object 15 is a collision threat, the sensor processing logic 350 may inform the vehicle controller 220 of the threat, and the vehicle controller 220 may take additional action in response to the threat. As an example, the vehicle controller 220 may control the vehicle 10 to avoid the threat, such as by adjusting a course of the vehicle 10 based on the assessment by the sensor processing logic 350 that the object 15 is a collision threat. The controller 220 may perform similar adjustments to the course of the vehicle 10 for each object 15 that the logic 350 identifies as a collision threat so that the vehicle 10 accomplishes safe self-piloted operation. As a further example, the vehicle controller 220 may provide a warning to a user or automatically control the vehicle's travel path to avoid the sensed object 15. Exemplary warnings may include messages, such as human-readable textual messages delivered to the vehicle's operator. Other exemplary warnings may include audible warnings (e.g., sirens), visible warnings (e.g., lights), physical warnings (e.g., haptics) or otherwise.

In other examples, the assessment by the sensor processing logic 350 may be used for other purposes. As an example, a detected object may be used for navigational purpose to determine or confirm the vehicle's location if the sensor data 343 is verified to be accurate. In this regard, the detected object may be used as a reference point for confirming the vehicle's location relative to the reference point and then controlling the vehicle 10 to guide it to a desired location relative to the reference point. The information about the sensed object 15 may be used for other purposes in yet other examples.

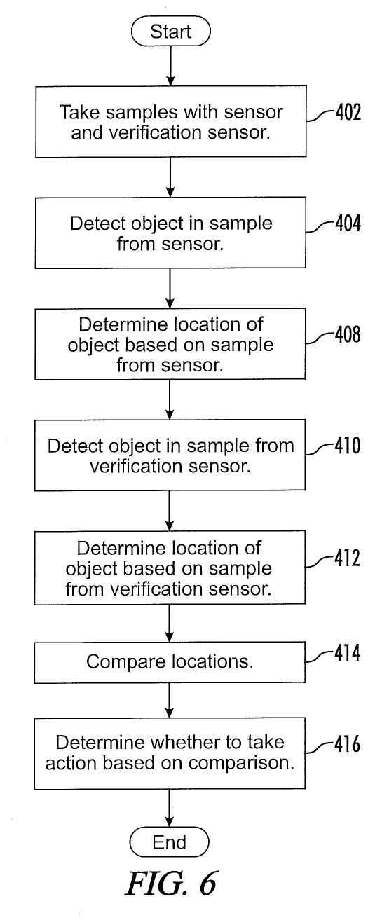

An exemplary use and operation of the system 5 in order to verify data from sensor 20 using verification data from verification sensor 30 will be described in more detail below with reference to FIG. 6. For illustrative purposes, it will be assumed that an object 15 is within the field of view 25 of a primary sensor 20 and field of view 35 of a verification sensor 30.

Initially, a sample is taken essentially simultaneously from each of the primary sensor 20 and the verification sensor 30 while an object 15 is within fields of view 25 and 35, as shown by block 402 of FIG. 6. Such samples are provided to the sensor processing logic 350, which detects the object 15 in the sample from the primary sensor 20, as shown by block 404 of FIG. 6. The sensor processing logic 350 then determines the location of the object 15 from the sample provided by the primary sensor 20, as shown by block 408 of FIG. 6.

As shown by block 410, the sensor processing logic 350 detects the same object 15 in the sample from the verification sensor 30. The sensor processing logic 350 then determines the location of the object 15 indicated by the sample provided by the verification sensor 30, as shown by block 412 of FIG. 6. After determining such location, the sensor processing logic 350 compares the location of the object 15 indicated by the sample from the verification sensor 30 to the location of the object 15 indicated by the sample from the primary sensor 20, as shown by block 414, and the sensor processing logic 350 verifies the location of the object 15 in the sensor data from the sensor 30 based on such comparison and determines whether to take action, as shown by block 416 of FIG. 4. In this regard, based on a difference in the compared locations, the sensor processing logic 350 may verify that the sensor data 343 from the sensor 30 accurately indicates coordinates of object 15. In such case, the sensor processing logic 350 may reliably use the sensor data 343 for tracking objects. If the sensor processing logic 350 determines that the sensor data 343 does not accurately reflect the location of the object 15, the sensor processing logic 350 takes an action to mitigate the discrepancy. As an example, the sensor processing logic 350 may report the discrepancy to the vehicle controller 220, which then make one or more control decisions based on the notification, such as changing the direction or speed of the vehicle 10. As shown by FIG. 6, processing for the samples collected at step 402 may end after block 416. Thereafter, new samples may be collected from each of sensor 20 and verification sensor 30, and processing may return to step 402 to repeat verification.

Various embodiments are described above as using a camera to implement the sensor 20, and using radar sensor to implement verification sensor 30. However, it should be emphasized that other types of primary sensors 20 and verification sensors 30 may be used both to perform tracking of objects and to perform verification of object locations according to the same or similar techniques described herein.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

1. A vehicular monitoring system, comprising:
a plurality of sensors positioned on an aircraft and configured to sense objects external to the aircraft within fields of view of the plurality of sensors, wherein the fields of view completely surround the aircraft, and wherein the plurality of sensors are configured to provide first data indicative of the objects;
at least one radar sensor positioned on the aircraft and configured to sense the objects, wherein the at least one radar sensor is configured to provide second data indicative of the objects; and
at least one processor configured to track the objects sensed by the plurality of sensors based on the first data, the at least one processor configured to perform a comparison between the first data and the second data and to determine whether to verify an accuracy of the first data based on the comparison without tracking the objects with the second data, wherein the at least one processor is configured to provide a warning based on the comparison if the first data fails to accurately indicate a location of an object sensed by the radar sensor.

2. A vehicular monitoring system, comprising:
a first sensor positioned on a vehicle, the first sensor configured to sense an object within a field of view for the first sensor and to provide first data indicative of a location of the object, wherein the object is external to the vehicle;
a radar sensor positioned on the vehicle, the radar sensor configured sense the object within the field of view and to provide second data indicative of a location of the object; and
at least one processor configured to track the object using the first data from the first sensor, the at least one processor configured to compare a sample of the first data and a sample of the second data for determining whether to verify an accuracy of the first data from the first sensor without tracking the object with the second data, wherein the at least one processor is configured to provide a warning in response to a discrepancy between the first data and the second data.

3. The system of claim 2, wherein the first sensor is an optical sensor.

4. The system of claim 2, wherein the vehicle is an aircraft.

5. The system of claim 2, wherein the vehicle is an automobile.

6. The system of claim 2, further comprising a vehicle controller configured to control a speed or direction of the vehicle based on the first data.

7. The system of claim 2, wherein the at least one processor is configured to determine whether the object is a collision threat for the vehicle based on the first data.

8. The system of claim 2, wherein the at least one processor is configured to compare the location indicated by the first data to the location indicated by the second.

9. The system of claim 2, further comprising a third sensor coupled to the vehicle, the third sensor configured to sense a second object within a field of view for the third sensor and to provide third data indicative of a location of the second object, wherein the second object is external to the vehicle, wherein the radar sensor is configured to sense the second object within the field of view for the third sensor, wherein the second data is indicative of a location of the second object, wherein the at least one processor is configured to track the second object using the third data from the third sensor, wherein the at least one processor is configured to compare a sample of the third data and a sample of the second data for verifying an accuracy of the third data from the third sensor without tracking the second object with the second data, and wherein the at least one processor is configured to provide a warning in response to a discrepancy between the third data and the second data.

10. A vehicular monitoring method, comprising:
sensing, with a first sensor positioned on a vehicle, an object within a field of view for the first sensor, wherein the object is external to the vehicle;
providing first data indicative of a location of the object based on the sensing with the first sensor;
sensing, with a radar sensor positioned on the vehicle, the object within the field of view;
providing second data indicative of a location of the object based on the sensing with the radar sensor;
tracking, with at least one processor, the object using the first data from the first sensor;
comparing, with the at least one processor, a sample of the first data and a sample of the second data;
determining a discrepancy between the first data and the second data based on the comparing;
determining, with the at least one processor, whether to verify an accuracy of the first data based on the discrepancy without tracking the object with the second data; and
providing a warning based on the determined discrepancy.

11. The method of claim 10, wherein the first sensor is an optical sensor.

12. The method of claim 10, wherein the vehicle is an aircraft.

13. The method of claim 10, wherein the vehicle is an automobile.

14. The method of claim 10, further comprising controlling a speed or direction of the vehicle based on the first data.

15. The method of claim 10, further comprising determining, with the at least one processor, whether the object is a collision threat for the vehicle based on the first data.

16. The method of claim 10, further comprising:
sensing, with a third sensor positioned on the vehicle, a second object within a field of view for the third sensor, wherein the second object is external to the vehicle;
providing third data indicative of a location of the second object based on the sensing with the third sensor;
sensing, with the radar sensor, the second object within the field of view for the third sensor, wherein the second data is indicative of a location of the second object;
comparing, with the at least one processor, a sample of the third data and a sample of the second data;
determining a second discrepancy between the third data and the second data based on the comparing the sample of the third data and the sample of the second data;
determining, with the at least one processor, whether to verify an accuracy of the third data based on the second discrepancy without tracking the second object with the second data; and
providing a warning based on the determined second discrepancy.
